(19) United States
(12) Patent Application Publication
(10) Pub. No.: US 2005/0026039 A1
(43) Pub. Date: Feb. 3, 2005

(54) Cobalt oxyhydroxide, method for producing the same and alkaline storage battery using the same

(75) Inventors: Kojiro Ito, Toyohashi-shi (JP); Kiyoshi Hayashi, Toyohashi-shi (JP); Toshihiro Yamada, Toyohashi-shi (JP)

Correspondence Address: MERCHANT & GOULD PC, P.O. BOX 2903, MINNEAPOLIS, MN, 55402-0903, US

(73) Assignees: MATSUSHITA ELECTRIC INDUSTRIAL CO., LTD., Kadoma-shi (JP); TOYOTA JIDOSHA KABUSHIKI KAISHA, Toyota-shi (JP)

(21) Appl. No.: 10/903,286

(22) Filed: Jul. 30, 2004

(30) Foreign Application Priority Data
Jul. 31, 2003 (JP) 2003-284139

(51) Int. Cl. H01M 4/52; C01G 51/04

(52) U.S. Cl. 429/223; 429/218.1; 423/594.19

(57) ABSTRACT

Novel cobalt oxyhydroxide is provided with which a positive electrode of an alkaline storage battery having conductivity higher than that of the conventional positive electrodes can be produced, and a method for producing the same is provided. Furthermore, an alkaline storage battery having a high capacity and that can be manufactured easily is provided. The cobalt oxyhydroxide is used for a positive electrode of an alkaline storage battery, in which a first peak corresponding to a crystal plane (003) of the cobalt oxyhydroxide and a second peak corresponding to a crystal plane (012) of the cobalt oxyhydroxide are present on a diffraction line obtained by X-ray diffraction measurement when employing copper Kα radiation as a radiation source, a half-power band width of the first peak is 0.6° or less, and a value obtained by dividing a strength of the first peak by a strength of the second peak is 10 or less.

### FIELD OF THE INVENTION

The present invention relates to cobalt oxyhydroxide, a method for producing the same and an alkaline storage battery using the same.

### BACKGROUND OF THE INVENTION

In recent years, alkaline storage batteries are used widely for electric vehicles and the like as well as for portable electronic equipment such as mobile phones and notebook PCs. For the alkaline storage batteries, further enhancement of capacity is required. One of the methods for increasing the capacity of alkaline storage batteries is to improve the electrical conductivity of a positive electrode so as to improve the utilization factor of an active material (positive-electrode active material). In order to improve the electrical conductivity of a positive electrode, a method utilized is to add a cobalt compound to a positive electrode, and it is known that, among the cobalt compounds, cobalt oxyhydroxide exhibits higher electrical conductivity.

Known methods for producing cobalt oxyhydroxide are, for example, as follows: (1) JP H10-21902 A discloses a method of synthesizing cobalt oxyhydroxide by heating an alkaline aqueous solution of cobalt (chemical precipitation method); and (2) JP H10-324523 A discloses a method of synthesizing cobalt oxyhydroxide by heating a suspension of cobalt (II) hydroxide while allowing the same to contact with an oxygen-containing gas.

However, the cobalt oxyhydroxide obtained by the above method (1) has poor crystallinity. For instance, when X-ray diffraction measurement is carried out with respect to the cobalt oxyhydroxide obtained by the above method (1), the strength obtained is rather small as a whole, and the diffraction line obtained has a broad peak. Furthermore, a crystal obtained by the above method (2) contains a large amount of cobalt oxide and unreacted cobalt hydroxide in addition to the cobalt oxyhydroxide. Therefore, it is difficult to improve the electrical conductivity of the positive electrode sufficiently by utilizing the cobalt oxyhydroxide obtained by these methods. In order to cope with these problems, JP 2002-216752 A discloses a method of forming β-cobalt oxyhydroxide (β-CoOOH) by baking cobalt (Co), cobalt oxide (CoO) or cobalt hydroxide (Co(OH)₂) at a temperature ranging from 80° C. to 150° C.

### SUMMARY OF THE INVENTION

Therefore, with the foregoing in mind, it is an object of the present invention to provide novel cobalt oxyhydroxide with which a positive electrode of an alkaline storage battery having conductivity higher than that of the conventional positive electrodes can be produced, and to provide a method for producing the same. It is another object of the present invention to provide an alkaline storage battery having a high capacity and that can be manufactured easily by using the above-stated novel cobalt oxyhydroxide.

Cobalt oxyhydroxide of the present invention may be used for a positive electrode of an alkaline storage battery. On a diffraction line obtained by X-ray diffraction measurement when employing copper Kα radiation as a radiation source, a first peak corresponding to a crystal plane (003) of the cobalt oxyhydroxide and a second peak corresponding to a crystal plane (012) of the cobalt oxyhydroxide are present, a half-power band width of the first peak is 0.6° or less, and a value obtained by dividing a strength of the first peak by a strength of the second peak is 10 or less.

Next, a method for producing cobalt oxyhydroxide of the present invention is for cobalt oxyhydroxide that may be used for a positive electrode of an alkaline storage battery, and the method includes the steps of:
(i) mixing an aqueous solution containing cobalt salt and an alkaline aqueous solution so as to form a first cobalt compound; and
(ii) adding an oxidizing agent to a solution containing the first cobalt compound so as to allow the first cobalt compound to react with the oxidizing agent, so that the cobalt oxyhydroxide is formed.

On a diffraction line obtained by X-ray diffraction measurement when employing copper Kα radiation as a radiation source, a first peak corresponding to a crystal plane (003) of the cobalt oxyhydroxide and a second peak corresponding to a crystal plane (012) of the cobalt oxyhydroxide are present, a half-power band width of the first peak is 0.6° or less, and a value obtained by dividing a strength of the first peak by a strength of the second peak is 10 or less.

Next, an alkaline storage battery of the present invention, includes: a positive electrode; and a negative electrode. The positive electrode includes a powder containing nickel hydroxide as a main component and a powder containing cobalt oxyhydroxide as a main component. On a diffraction line obtained by X-ray diffraction measurement when employing copper Kα radiation as a radiation source, a first peak corresponding to a crystal plane (003) of the cobalt oxyhydroxide and a second peak corresponding to a crystal plane (012) of the cobalt oxyhydroxide are present, a half-power band width of the first peak is 0.6° or less, and a value obtained by dividing a strength of the first peak by a strength of the second peak is 10 or less.

### BRIEF DESCRIPTION OF THE DRAWINGS

FIG. 1 shows one example of the X-ray diffraction profile of cobalt oxyhydroxide of the present invention.

FIG. 2 is a schematic view showing one example of an alkaline storage battery of the present invention.

### DETAILED DESCRIPTION OF THE INVENTION

The following describes embodiments of the present invention. In the following descriptions of the embodiments, the same reference numerals may be assigned to the same elements so as to avoid the duplication of descriptions.

Firstly, cobalt oxyhydroxide of the present invention will be described below.

In the present invention, the cobalt oxyhydroxide refers to β-cobalt oxyhydroxide (β-CoOOH). The β-cobalt oxyhydroxide is a crystal having a hexagonal group crystal structure, in which a plane interval of a crystal plane (003) is within a range of 0.35 nm to 0.53 nm. The β-cobalt oxyhydroxide of the present invention has the following features: a first peak corresponding to the crystal plane (003) and a second peak corresponding to a crystal plane (012) are present on a diffraction line (X-ray diffraction profile) obtained by X-ray diffraction (XRD) measurement; a half-power band width of the first peak is 0.6° or less; and a value obtained by dividing a strength of the first peak by a strength of the second peak is 10 or less (preferably, from 0.5 to 3.5, inclusive). Specific examples of the X-ray diffraction profile (hereinafter, also simply referred to as “diffraction profile”) for the cobalt oxyhydroxide of the present invention will be described later in the section of Examples.

Such cobalt oxyhydroxide has high crystallinity. Furthermore, the use of such cobalt oxyhydroxide allows a positive electrode of an alkaline storage battery having conductivity higher than that of the conventional positive electrodes to be produced. Although a specific driving force that enables the production of a positive electrode having higher conductivity has not been clarified, there is a possibility that a network of cobalt that is denser than the conventional one is formed in the positive electrode. Furthermore, the use of such cobalt oxyhydroxide can realize an alkaline storage battery that has a high capacity and can be manufactured easily. The cobalt oxyhydroxide of the present invention can be formed by the cobalt oxyhydroxide producing method of the present invention, which will be described later.

A method of measuring XRD is not limited especially, and a general XRD measurement technique can be used. A specific example follows: a measurement cell, made of glass, is filled uniformly with a powder specimen to reach about 1 mm in depth, and a surface on which X-rays are incident is made smooth. Following this, XRD measurement may be carried out, for example, at a measurement speed of 2.4° (diffraction angle)/min, a scanning step of 0.02° and over a range of a measurement diffraction angle of 5° to 85°. A radiation source of the X-rays is not limited especially, and copper Kα radiation (CuKα radiation: wavelength of 1.5405 nm) may be used, for example. In the case where the CuKα radiation is used as the radiation source, a first peak corresponding to a crystal plane (003) is observed in the vicinity of 19.3° to 20.3° on a diffraction profile, which is represented with a diffraction angle of 2θ. A second peak corresponding to a crystal plane (012) is observed in the vicinity of 38.3° to 39.3°, which is represented with a diffraction angle of 2θ.

A half-power band width of the first peak may be determined using a general technique from the diffraction profile obtained by the XRD measurement with respect to the cobalt oxyhydroxide. The half-power band width being 0.6° or less means that a width of a peak having half of the peak strength is 0.6° or less in terms of a diffraction angle. Strengths of the first and the second peaks may be determined by performing a general technique for obtaining a peak strength with respect to the obtained diffraction profile, including the elimination of background strengths, the normalization for strength correction and the like.

The following describes a method for producing the cobalt oxyhydroxide of the present invention. According to this method, firstly, an aqueous solution containing cobalt salt and an alkaline aqueous solution are mixed so as to form a first cobalt compound (step (i)). The cobalt salt is not limited especially, and a strong acid salt of cobalt such as CoSO₄ or CoCl₂ may be used. Two or more kinds of cobalt salts may be combined therefor. Available alkaline aqueous solutions include an aqueous solution containing, as a dissolved substance, at least one selected from LiOH, NaOH and KOH. A pH of the alkaline aqueous solution may range from 10 to 14, for example. The alkaline aqueous solution may be added so that the ratio of the alkaline aqueous solution to the cobalt salt is in excess with reference to their stoichiometric ratio. More specifically, the alkaline aqueous solution may be added so that the amount of hydroxide of alkaline metal is 2.5 times or more with reference to the cobalt salt in terms of a molar ratio. For instance, when a CoSO₄ aqueous solution and a KOH aqueous solution are mixed, a reaction of CoSO₄+2KOH→Co(OH)₂+K₂SO₄ occurs so as to form Co(OH)₂ as the first cobalt compound.

In the step (i), preferably, a temperature of the reactive solution is kept in a range of 10° C. to 130° C. (more preferably, 50° C. to 70° C.). The first cobalt compound that is a product of reaction is Co(OH)₂, which is a divalent cobalt compound. In the method of the present invention, it is useful to allow the reaction in the step (i) to progress thoroughly before going to the next step (ii). If an oxidizing agent is added in a state where the reaction has not progressed sufficiently, a product has low purity and a peak observed in the X-ray diffraction profile becomes broad. It is difficult to obtain an alkaline storage battery having favorable properties from such a product. Therefore, it is preferable in the step (i) that the aqueous solution containing cobalt salt and the alkaline aqueous solution are mixed, followed by the stirring of the reactive solution for at least 30 minutes. This allows Co(OH)₂ to be generated more reliably.

Following this, an oxidizing agent is added to the solution containing the first cobalt compound so as to allow the first cobalt compound to react with the oxidizing agent, whereby cobalt oxyhydroxide is obtained (step (ii)). The simplest way to carry out the step (ii) is to add the oxidizing agent further to the reactive solution of the step (i). The cobalt oxyhydroxide obtained from this step is the previously described β-CoOOH of the present invention. As the oxidizing agent, at least one selected from K₂S₂O₈, Na₂S₂O₈, (NH₄)₂S₂O₈, H₂O₂, NaClO, KMnO₄, LiOH, NaOH and KOH may be used, for example. Among them, at least one selected from K₂S₂O₈, Na₂S₂O₈, (NH₄)₂S₂O₈, H₂O₂, NaClO and KMnO₄ is preferable. These oxidizing agents may be used alone or in combination with others. These oxidizing agents may be added in the form of an aqueous solution, for example. In the step (ii), preferably, a temperature of the solution with the oxidizing agent added thereto is kept in a range of 10° C. to 80° C., inclusive (more preferably, 50° C. to 70° C., inclusive). A pH of the solution with the oxidizing agent added thereto preferably is kept at 10 or more (more preferably, 14 or more). When the reaction proceeds at 80° C. or lower, the generation of tricobalt tetroxide (Co₃O₄) can be suppressed. If a large amount of tricobalt tetroxide is generated, the purity of the product deteriorates, which may lead to a failure to improve the properties of an alkaline storage battery sufficiently. When the reaction proceeds at 10° C. or higher, the reaction can progress thoroughly, whereby cobalt oxyhydroxide with high purity and high crystallinity can be formed.

The step (ii) is conducted preferably while performing the bubbling of the above-stated solution with a gas containing oxygen. Available gases containing oxygen include an oxygen gas, air and a mixed gas of nitrogen and oxygen, for example. The bubbling in the step (ii) may be performed after the mixing of the solution containing the first cobalt compound with the oxidizing agent. Alternatively, the oxidizing agent may be added to the solution containing the first cobalt compound formed in the step (i) while performing the bubbling thereto. The specific technique of the bubbling is not limited especially.

As a result of such a production method, cobalt oxyhydroxide can be obtained so that a first peak corresponding to the crystal plane (003) and a second peak corresponding to the crystal plane (012) are present on a diffraction line (X-ray diffraction profile) obtained by X-ray diffraction (XRD) measurement, in which a half-power band width of the first peak is 0.6° or less and a value obtained by dividing a strength of the first peak by a strength of the second peak is 10 or less, which means that the cobalt oxyhydroxide has high crystallinity. Furthermore, according to the producing method of the present invention, the step (i) and the step (ii) can be performed in the form of solution. That is, β-cobalt oxyhydroxide with high crystallinity can be obtained by means of the wet procedure.

The following describes an alkaline storage battery of the present invention. The alkaline storage battery of the present invention is a nickel metal-hydride storage battery or a nickel-cadmium storage battery. The alkaline storage battery of the present invention includes a case and a positive electrode, a negative electrode, a separator and an electrolyte that are enclosed in the case. The separator is supported by the positive electrode and the negative electrode so as to be sandwiched therebetween. A specific configuration example of the alkaline storage battery of the present invention will be described later in the section of examples.

The positive electrode includes a conductive support and an active material layer that is supported by the support. The active material layer includes active material powder and powder of the above-described β-cobalt oxyhydroxide of the present invention. As the active material powder, one generally used for alkaline storage batteries may be used. For example, powder of nickel hydroxide and powder including solid solution particles that contain nickel hydroxide as the main component may be used. With respect to 100 parts by weight of active material powder, the cobalt oxyhydroxide may be added in the amount ranging from 1 part by weight to 20 parts by weight, for example. Among them, a range from 3 parts by weight to 10 parts by weight is preferable. With this configuration, an alkaline storage battery can have a high capacity and can be manufactured easily.

The positive electrode further may contain powder of other cobalt compounds, such as cobalt metal and cobalt hydroxide (Co(OH)₂). This allows an alkaline storage battery with a still higher capacity to be attained.

In the alkaline storage battery of the present invention, as members other than the positive electrode, those generally used for alkaline storage batteries may be used. More specifically, as the negative electrode, a negative electrode using a hydrogen-absorbing alloy (nickel metal-hydride storage battery) or a negative electrode containing cadmium (nickel-cadmium storage battery) may be used. As the separator, a polyolefin non-woven cloth that has been treated to have hydrophilicity may be used, for example. As the electrolyte, an alkaline electrolyte containing potassium hydroxide or lithium hydroxide as a main dissolved substance and having a specific gravity of approximately 1.3 may be used. Note here that the shape and the size of the alkaline storage battery of the present invention are not limited especially and may have any shapes such as a cylindrical shape and a rectangular shape. The alkaline storage battery of the present invention is applicable to not only a compact storage battery used for a mobile phone but also a large storage battery used for an electric vehicle, which are non-limiting examples.

### EXAMPLES

The following are more detailed descriptions for the present invention, referring to examples. The present invention is not limited to the following examples.

(Production of β-CoOOH)

Firstly, 14.1 g of CoSO₄.7H₂O (produced by Kanto Kagaku K.K.) was dissolved into 300 ml of ion-exchanged water at a predetermined temperature. This was performed slowly so as not to change the temperature of the solution while stirring the ion-exchanged water mechanically. Thereby, an aqueous solution containing cobalt salt was prepared. Next, an aqueous sodium hydroxide of 1 mol/L in concentration was added as an alkaline aqueous solution to the thus prepared aqueous solution, followed by stirring for about 30 minutes (step (i)). Next, a 500 ml of hydrogen peroxide solution with a concentration of 30 weight % was added as an oxidizing agent to the thus stirred solution, followed by stirring for about 6 hours while keeping a temperature and a pH of the solution at predetermined values (step (ii)). In this way, a cobalt compound was produced. The thus produced cobalt compound was filtered, thereafter was washed with water and dried. The compound obtained after the drying was brown powder. In this example, the temperature and the pH of the solution; with or without the bubbling with oxygen; and with or without the oxidizing agent were changed in the step (ii) so as to produce a plurality of types of cobalt compounds. The reactive conditions are shown in Table 1.

TABLE 1

| | Temperature | | | |
|---|---|---|---|---|
| | of solution | pH of | Oxidizing | |
| | [° C.] | solution | agent | Oxygen bubbling |
| Sample A | 10 | 14 | H₂O₂ | None |
| Sample B | 60 | 14 | H₂O₂ | None |
| Sample C | 75 | 14 | H₂O₂ | None |
| Sample D | 60 | 10 | H₂O₂ | None |
| Sample E | 60 | 12 | H₂O₂ | None |
| Sample F | 60 | 14 | H₂O₂ | None |
| Sample G | 80 | 14 | H₂O₂ | Done |
| Comp. Sample 1 | 90 | 14 | H₂O₂ | None |
| Comp. Sample 2 | 60 | 14 | None | Done |
| Comp. Sample 3 | 80 | 14 | None | Done |
| Comp. Sample 4 | 60 | 9 | H₂O₂ | None |
| Comp. Sample 5 | — | — | — | — |
| (dry process) | | | | |

As shown in Table 1, as for Sample G, Comparative Sample 2 and Comparative Sample 3, the step (ii) was conducted while performing bubbling with air (oxygen percentage: about 20 volume %) at a flow rate of 1 liter/minute. Comparative Sample 5 is cobalt oxyhydroxide that was produced by the conventional dry process. More specifically, Comparative Sample 5 was produced by spreading Co(OH)₂ over a low-profile tray, which was heated at 130° C. for 5 hours in an atmosphere of air.

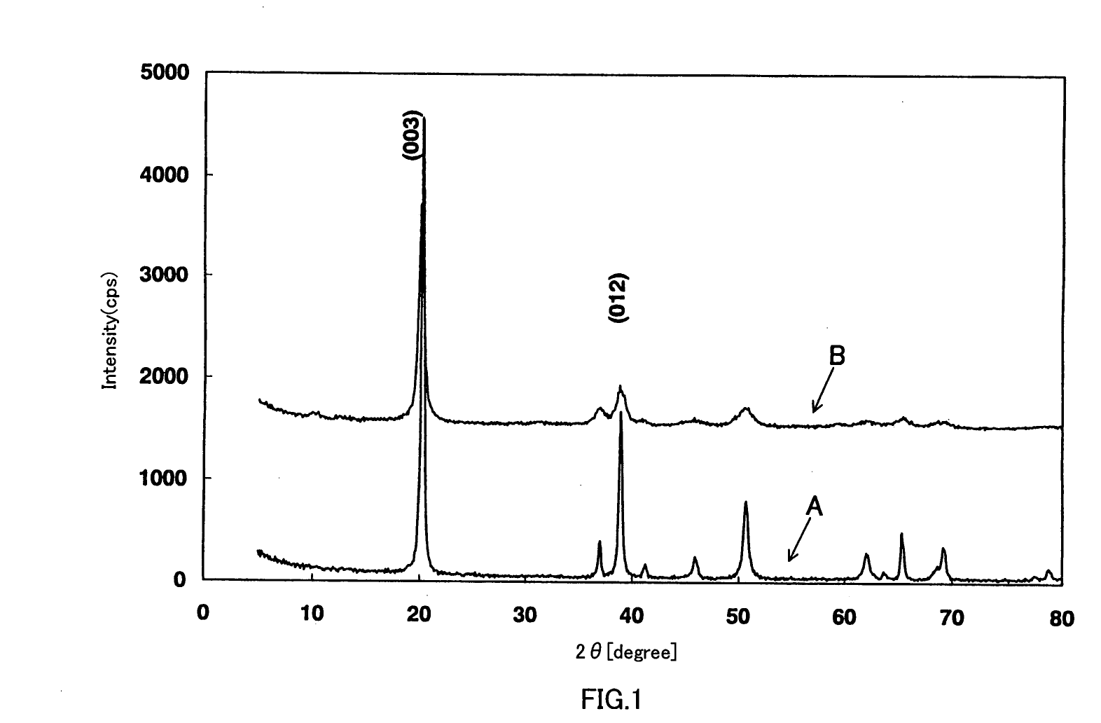

XRD measurement was conducted over a range of a diffraction angle 2θ of 5° to 80° with respect to the thus produced 12 types of cobalt compounds, where CuKα radiation was used as a X-ray source. The measurement equipment apparatus used was RINT-2200 (produced by Rigaku Corporation). As one example, A of FIG. 1 shows the measurement results of Sample G (diffraction profile) and B of FIG. 1 shows the measurement results (diffraction profile) of Comparative Sample 1. The produced compounds were identified using JCPDS (Joint Committee on Powder Diffraction Standards) card. As a result of the identification, it turned out that the produced compounds contained cobalt oxyhydroxide (No. 70169 in JCPDS card). The identified compounds are shown in Table 2. Furthermore, based on JCPDS card, indexes were assigned to the respective peaks, and a half-power band width of a peak of (003) that was observed in the vicinity of 2θ=19.3° to 20.3°, and a strength ratio between a strength of a peak of (012) that was observed in the vicinity of 2θ=38.3+ to 39.3° and a strength of the peak of (003) i.e., (003)/(012), were determined. These values are shown in the following Table 2.

Furthermore, valences (oxidation order) of cobalt in the produced compounds were determined by an iodometric titration flow method. The valences of cobalt in the respective compounds are shown in Table 2. The cobalt in the cobalt compounds that can be generated through the step (i) and the step (ii) has the following valences: Co(OH)₂ has the valence of 2, Co₃O₄ has the valence of 2.67 and β-CoOOH has the valence of 3. Therefore, it can be considered that as the generation ratio of β-CoOOH increases, the valence of cobalt increases (becomes close to 3).

TABLE 2

| | | (003) | | | |
|---|---|---|---|---|---|
| | | half-power | (003)/(012) | | Utilization factor |
| | | band width | strength | Co | of active material |
| | Products | [degree] | ratio | valence | [%] |
| Sample A | β-CoOOH | 0.529 | 9.28 | 2.91 | 96.8 (battery A) |
| Sample B | β-CoOOH | 0.457 | 3.77 | 2.95 | 98.1 (battery B) |
| Sample C | β-CoOOH | 0.466 | 3.85 | 2.95 | 97.2 (battery C) |
| Sample D | β-CoOOH | 0.471 | 8.56 | 2.96 | 97.9 (battery D) |
| Sample E | β-CoOOH | 0.424 | 3.98 | 2.99 | 99.9 (battery E) |
| Sample F | β-CoOOH | 0.502 | 3.22 | 2.93 | 99.9 (battery F) |
| Sample G | β-CoOOH | 0.282 | 2.96 | 2.99 | 99.9 (battery G) |
| Comp. | β-CoOOH + | 0.603 | 12.20 | 2.55 | 76.3 |
| Sample 1 | Co₃O₄ | | | | (Comp. Battery 1) |
| Comp. | β-CoOOH + | 0.622 | 13.56 | 2.47 | 72.7 |
| Sample 2 | Co₃O₄ | | | | (Comp. Battery 2) |
| Comp. | β-CoOOH + | 0.635 | 14.73 | 2.44 | 69.8 |
| Sample 3 | Co₃O₄ | | | | (Comp. Battery 3) |
| Comp. | β-CoOOH + | 0.628 | 13.29 | 2.48 | 74.4 |
| Sample 4 | Co₃O₄ | | | | (Comp. Battery 4) |
| Comp. | β-CoOOH | 0.588 | 10.50 | 2.78 | 92.2 |
| Sample 5 | | | | | (Comp. Battery 5) |
| (dry process) | | | | | |

As shown in Table 2, judging from the results of the products and the valences of cobalt, it was found that β-CoOOH with higher purity could be produced from Samples A to G than Comparative Samples. Furthermore, judging from the results of the half-power band width of the (003) peak and the strength ratio of (003)/(012), it was found that β-CoOOH with higher crystallinity could be produced from Samples A to G than Comparative Examples. Among the comparative examples, Comparative Example 5 had higher purity and higher crystallinity than those of

### Comparative Examples 1 to 4

(Production of Nickel Metal-Hydride Storage Battery)

Next, 12 types of nickel metal-hydride storage batteries were produced using the above-stated 12 types of cobalt compounds. Firstly, 90 parts by mass of nickel hydroxide powder, 5 parts by mass of cobalt metal and 5 parts by mass of one of the above-stated cobalt compounds (any one of Samples A to G and Comparative Samples 1 to 5) were added to water, followed by kneading, so that an active material paste was produced. Next, this active material paste was charged in a porous nickel foam (porosity: 95%, surface density: 450 g/m²), and after drying and compressing, it was cut into a prescribed size. Thus, a positive electrode with a theoretical capacity of 1,000 mAh was produced. In this way, 12 types of positive electrode plates were formed to which different cobalt compounds (Samples A to G and Comparative Samples 1 to 5) had been added.

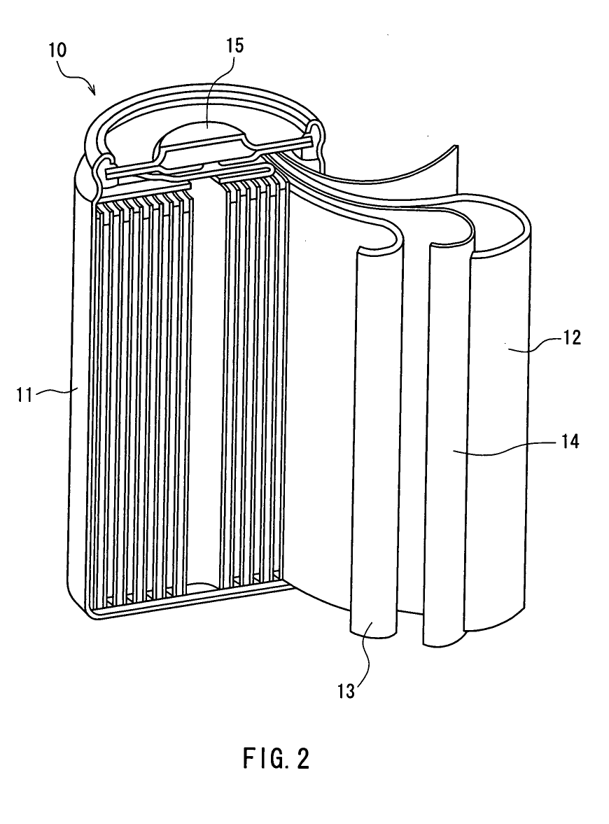

Next, hermetic AA-sized nickel metal-hydride storage batteries were produced using the thus produced 12 types of positive electrode plates. A partially exposed perspective view of one of the thus produced nickel metal-hydride storage batteries is shown in FIG. 2. A nickel metal-hydride storage battery 10 shown in FIG. 2 is provided with: a case 11 that doubles as a negative electrode terminal; a positive electrode plate 12, a negative electrode plate 13, a separator 14 and an electrolyte (not illustrated) that are enclosed in the case 11; and a sealing plate 15 equipped with a safety valve. The separator 14 is arranged between the positive electrode plate 12 and the negative electrode plate 13.

As the positive electrode plate 12, one of the above-described 12 types of positive electrode plates was used. As the negative electrode plate 13, a negative electrode plate containing a hydrogen-absorbing alloy (MmNi_{3.6}Co_{0.7}Mn_{0.4}Al_{0.3}, where Mm denotes misch metal) was used. As the separator 14, a sulfonated polypropylene separator was used. The electrolyte used was a potassium hydroxide aqueous solution having a specific gravity of 1.3 in which lithium hydroxide was dissolved to obtain a concentration of 20 g/liter.

First of all, the positive electrode plate 12 and the negative electrode plate 13 were opposed to each other with the separator 14 held and sandwiched therebetween, which was rolled up and disposed inside the case 11. Thereafter, 2.0 cm³ of the electrolyte was poured in the case 11, which was sealed with the sealing plate 15. In this way, 12 types of nickel metal-hydride storage batteries were produced in which cobalt compounds contained in their positive electrode plates were different from one another. In the following description, the batteries employing the cobalt compounds of Samples A to G will be referred to as batteries A to G, respectively, and the batteries employing the cobalt compounds of Comparative Examples 1 to 5 will be referred to as comparative batteries 1 to 5, respectively.

Next, the thus produced batteries were subjected to a 10 repetition charge/discharge cycle test. The charge/discharge was conducted by, as one cycle, charging the battery with 200 mA (0.2 C) until the SOC (State Of Charge) reached 120%, and then by discharging the battery with 200 mA until the battery voltage reached 1.0 V. Then, the discharge capacity at the 10^{th} cycle was measured so as to calculate the utilization factor of the active material. More specifically, the utilization factor of the active material was calculated according to the following formula: the utilization factor of the active material (%)=(the discharge capacity at the 10^{th} cycle)×100/(the theoretical capacity of the battery). The calculated utilization factors of the active materials are shown in the above Table 2.

As shown in Table 2, batteries A to G employing cobalt oxyhydroxide with a half-power band width of a peak corresponding to a crystal plane (003) less than 0.6° and a value of the peak strength ratio (003)/(012) not more than 10, which were determined by the XRD measurement using copper Kα radiation as a radiation source, yielded higher active material utilization factors as compared with those of comparative batteries 1 to 5. Although reasons for this have not been clarified, conceivably, this is based on the following reason. That is, the enhancement of crystallinity of cobalt oxyhydroxide increases concurrently the reactivity with cobalt metal added to the positive electrode in the battery, thus forming a denser conductive network of cobalt.

Furthermore, although the positive electrode plates in this example were manufactured with the cobalt metal powder added in addition to the active material powder and the cobalt oxyhydroxide powder, approximately the same results could be obtained when cobalt hydroxide was added instead of the cobalt metal for the positive electrode plates.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. Cobalt oxyhydroxide used for a positive electrode of an alkaline storage battery,
wherein, on a diffraction line obtained by X-ray diffraction measurement when employing copper Kα radiation as a radiation source, a first peak corresponding to a crystal plane (003) of the cobalt oxyhydroxide and a second peak corresponding to a crystal plane (012) of the cobalt oxyhydroxide are present,
a half-power band width of the first peak is 0.6° or less, and
a value obtained by dividing a strength of the first peak by a strength of the second peak is 10 or less.

2. A method for producing cobalt oxyhydroxide used for a positive electrode of an alkaline storage battery, comprising the steps of:
(i) mixing an aqueous solution containing cobalt salt and an alkaline aqueous solution so as to form a first cobalt compound; and
(ii) adding an oxidizing agent to a solution containing the first cobalt compound so as to allow the first cobalt compound to react with the oxidizing agent, so that the cobalt oxyhydroxide is formed,
wherein, on a diffraction line obtained by X-ray diffraction measurement when employing copper Kα radiation as a radiation source, a first peak corresponding to a crystal plane (003) of the cobalt oxyhydroxide and a second peak corresponding to a crystal plane (012) of the cobalt oxyhydroxide are present, a half-power band width of the first peak is 0.6° or less, and a value obtained by dividing a strength of the first peak by a strength of the second peak is 10 or less.

3. The method for producing cobalt oxyhydroxide according to claim 2, wherein, in the step (ii), the cobalt oxyhydroxide is formed by keeping a temperature of the solution to which the oxidizing agent has been added in a range from 10° C. to 80° C., inclusive, and by keeping a pH of the solution to which the oxidizing agent has been added to be 10 or more.

4. The method for producing cobalt oxyhydroxide according to claim 2, wherein the oxidizing agent comprises at least one selected from the group consisting of K₂S₂O₈, Na₂S₂O₈, (NH₄)₂S₂O₈, H₂O₂, NaClO, KMnO₄, LiOH, NaOH and KOH.

5. The method for producing cobalt oxyhydroxide according to claim 2, wherein the step (ii) is conducted while performing bubbling of the solution with a gas containing oxygen.

6. An alkaline storage battery, comprising:
a positive electrode; and
a negative electrode,
wherein the positive electrode comprises a powder containing nickel hydroxide as a main component and a powder containing cobalt oxyhydroxide as a main component, and
on a diffraction line obtained by X-ray diffraction measurement when employing copper Kα radiation as a radiation source, a first peak corresponding to a crystal plane (003) of the cobalt oxyhydroxide and a second peak corresponding to a crystal plane (012) of the cobalt oxyhydroxide are present, a half-power band width of the first peak is 0.6° or less, and a value obtained by dividing a strength of the first peak by a strength of the second peak is 10 or less.

7. The alkaline storage battery according to claim 6, wherein the positive electrode further comprises cobalt metal.
